(19) United States
(12) Patent Application Publication
(10) Pub. No.: US 2016/0200293 A1
(43) Pub. Date: Jul. 14, 2016

(54) UNDERCARRIAGE VEHICLE WASHER

(71) Applicant: Timothy McKeen, Syracuse, NY (US)

(72) Inventor: Timothy McKeen, Syracuse, NY (US)

(21) Appl. No.: 14/595,402

(22) Filed: Jan. 13, 2015

(51) Int. Cl. B60S 3/04

(52) U.S. Cl. CPC B60S 3/044

(57) ABSTRACT

An undercarriage vehicle washer comprising a Z-shaped body, where the Z-shaped body extends between a handle and an undercarriage portion each connected with a pair of elbow joints; a fitting attached to the handle, where the fitting connects the Z-shaped body to a water hose; a sprayer coupled to an end of the undercarriage portion, where the sprayer directs an upward stream toward an undercarriage of a vehicle; a pair of wheels attached to the sprayer.

### BACKGROUND OF THE INVENTION

1. Field of the Invention

The present invention relates to a vehicle washing device that sprays water while being operating by a user standing upright next to the vehicle.

2. Description of Related Art

Vehicle owners, especially vehicle enthusiasts, thoroughly detail their cars, taking time to clean and polish the interior, exterior and under the hood. While cleaning the interior, care is taken to vacuum, wipe and shine each surface even below the seats and next to the console.

While cleaning the exterior, all surfaces are scrubbed and polished to shine and remove any visible markings like scratches or prints. The task may be time consuming but the final result of a clean and spotless vehicle is rewarding.

An area of particular difficulty is the undercarriage, because this area is repeatedly exposed to dirt and debris on the road and kickback from the tires. The dirt gets into hard to reach nooks which can cause malfunction to the various moving parts of machinery. For optimal performance the undercarriage should be cleaned routinely, but this is difficult with such a hard to see and reach area. Most of the time the cars are taken to a professional mechanic or detailer who has the equipment to lift the vehicle and then easily access the intricate machinery. Over time this can be very costly resulting in a strain on the wallet rather than a strain on the back.

Therefore it would be beneficial in the art to provide a way for a person to easily wash their vehicle's undercarriage without having to lay on the floor to do so. It would also be desirable in the art to provide a washing device with wheels to allow easy maneuverability.

### SUMMARY OF THE INVENTION

In view of the foregoing disadvantages inherent in the prior art, the general purpose of the present invention is to provide an undercarriage washer for a vehicle, configured to include all of the advantages of the prior art, and to overcome the drawbacks inherent therein.

Accordingly, an object of the present invention is to provide an undercarriage vehicle washer with a Z-shaped body, including a handle at one end and a sprayer at an opposing end. The Z-shaped body allows the user to stand upright while they push the sprayer beneath the vehicle for cleaning

Another object of the present invention is to provide an undercarriage vehicle washer where the sprayer is mounted on caster wheels for easy maneuvering.

To achieve the above objects, in an aspect of the present invention, an undercarriage vehicle washer comprising is described a Z-shaped body, where the Z-shaped body extends between a handle and an undercarriage portion each connected with a pair of elbow joints; a fitting attached to the handle, where the fitting connects the Z-shaped body to a water hose; a sprayer coupled to an end of the undercarriage portion, where the sprayer directs an upward stream toward an undercarriage of a vehicle; a pair of wheels attached to the sprayer.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an undercarriage vehicle washer in accordance with an exemplary embodiment of the present invention; and

FIG. 2 depicts a front view of a sprayer in accordance with an exemplary embodiment of the present invention.

Like reference numerals refer to like parts throughout the description of several views of the drawings.

### DETAILED DESCRIPTION OF THE DRAWINGS

The present invention relates to a vehicle washing device that sprays water while being operating by a user standing upright next to the vehicle. The present invention provides an undercarriage vehicle washer to facilitate the process of cleaning beneath vehicles. The undercarriage vehicle washer includes a Z-shaped pipe system that aims a water stream directly towards the structures beneath the vehicle. The washer is able to adjust the stream of water to increase and decrease water pressure as needed on the various components. The sprayer portion of the washer is mounted upon a pair of caster wheels to allow for easy maneuverability while traversing the ground below the vehicle. The undercarriage vehicle washer is made from PVC pipes for durability, thereby promoting a thorough cleaning in any conditions.

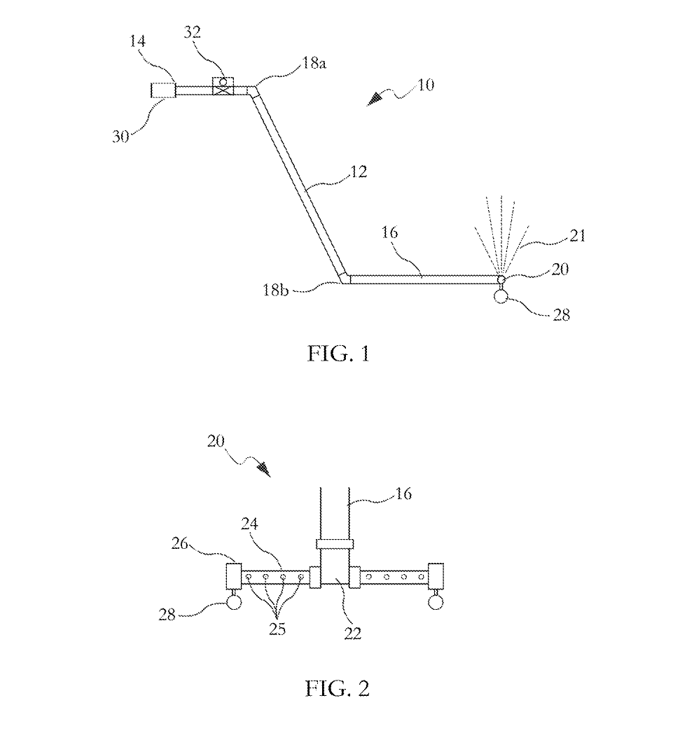

Turning now descriptively to the drawings, referring to FIG. 1, a perspective view of an undercarriage vehicle washer 10 is shown in accordance with an exemplary embodiment of the present invention. The undercarriage vehicle washer 10 includes a Z-shaped body 12 extending between a handle 14 and an undercarriage portion 16. The Z-shaped body 12 may be a system of PVC pipes that are connected at elbow joints 18a, 18b to abruptly change the direction of the pipes. The elbow joints 18a, 18b may be corrugated to enable adjustments so that the user can change the angles of the handle 14 and undercarriage portion 16 as they are working. Alternatively, aluminum may be used to provide a lightweight, metallic Z-shaped body 12.

The handle 14 provides a hand support for the user to control how the undercarriage portion 16 moves beneath a vehicle. The handle 14 may be padded and/or ergonomically shaped for a comfortable feel within the user's hand. At an end of the handle 14 may be a fitting 30. The fitting 30 attaches the Z-shaped body 12 to a water hose. The fitting 30 attaches to a standard garden hose to allow exchange between users at various locations. On the handle 14, near the first elbow joint 18a, may be a valve 32. The valve 32 may be a ball-valve that stops and adjusts the water pressure from the garden hose as it travels through the rest of the Z-shaped body 12. The valve 32 stoppers the water so that the spray to the various parts of the vehicle is adjusted according to the delicate nature of the part.

At an opposing end of the undercarriage portion 16 from the second elbow joint 18b is a sprayer 20. The sprayer 20 is mounted atop a pair of wheels 28 for easy maneuverability. The sprayer 20 projects an upward stream 21 that sprays the undercarriage of the vehicle.

Referring now to FIG. 2, a top view of the sprayer 20 is shown in accordance with an exemplary embodiment of the present invention. The sprayer 20 includes a T-joint 22 attached at the end of the undercarriage portion 16. From the T-joint 22 are a pair of discharge pipes 24. The discharge pipes 24 includes a plurality of top positioned holes 25 to direct the water upwards. At each end of the discharge pipes 24 is an end cap 26. The wheels 28 are coupled to the end caps 28. The wheels 28 may be caster wheels to enable easy swiveling, pivoting and direction change while washing. With the undercarriage vehicle washer 10 the user is able to thoroughly clean and sanitize their vehicle without going to a professional shop or straining and exhausting their bodies trying to reach under the car. It saves time, money and effort by allowing the user to wash their own vehicles at home.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An undercarriage vehicle washer comprising:
a. a Z-shaped body, where the Z-shaped body extends between a handle and an undercarriage portion each connected with a pair of elbow joints, wherein the elbow joints are corrugated thereby allowing angle adjustments along the z-shaped body;
b. a fitting attached to the handle, where the fitting connects the Z-shaped body to a water hose;
c. a sprayer coupled to an end of the undercarriage portion, where the sprayer directs an upward stream toward an undercarriage of a vehicle;
d. a pair of wheels attached to the sprayer.

2. The undercarriage vehicle washer according to claim 1, where the Z-shaped body is made from PVC pipe.

3. The undercarriage vehicle washer according to claim 1, where the handle includes a valve, where the valve controls the water flow through the Z-shaped body.

4. The undercarriage vehicle washer according to claim 1, where the sprayer includes:
a. a T-joint attached at an end of the undercarriage portion;
b. a pair of discharge pipes attached to the T-joint, where the pair of discharge pipes include a plurality of holes through which the water stream sprays; and
c. an end cap at each end of the discharge pipe, where the end cap attaches the pair of wheels to the sprayer.

5. The undercarriage vehicle washer according to claim 1, where the undercarriage portion includes a wheel where the undercarriage portion attaches to the elbow joint.

6. The undercarriage vehicle washer according to claim 1, where the handle is padded.

7. The undercarriage vehicle washer according to claim 1, where the handle is ergonomically shaped.

8. The undercarriage vehicle washer according to claim 1, where the pair of wheels are caster wheels.

9. (canceled)
